(19) United States
(12) Patent Application Publication
(10) Pub. No.: US 2012/0006889 A1
(43) Pub. Date: Jan. 12, 2012

(54) CARTON AND METHOD FOR PRODUCING THE SAME

(76) Inventor: William Lin, Shenzhen (CN)

(21) Appl. No.: 12/832,388

(22) Filed: Jul. 8, 2010

(51) Int. Cl. B65D 5/42; B31B 1/14

(52) U.S. Cl. 229/122.32; 493/56

(57) ABSTRACT

A carton includes a cuboid body and a cuboid cover both formed by folding paper board. The body includes first through fourth external wall plates connected through creases. The bottom edge of the first external wall plate is connected with an inner bottom plate. The bottom edge of the third external wall plate is connected with an external bottom plate, and two side edges of the external bottom plate are connected with a second internal wall plate and a fourth internal wall plate. The first through fourth external wall plates and the external bottom plate form a cuboid structure. A second internal wall plate is in contact with the inner surface of the second external wall plate. The fourth internal wall plate is in contact with the inner surface of the fourth external wall plate. The inner bottom plate in contact with the inner surface of the external bottom plate.

### FIELD OF THE INVENTION

The present invention relates to a packaging product, particularly to a carton and a method for producing the same.

### BACKGROUND OF THE INVENTION

Paper boxes or cartons for packaging, which are made of corrugated paper board, have incomparable advantages in the aspects of cost saving, item protection, eco-friendship, crushing resistance, and load bearing performance as compared with boxes made of other materials (such as wood or metal). At present, the bottom of the carton currently used in the market is designed to be formed by joining small pieces together with the aid of external tools or materials (for example, staples and adhesive tapes, etc.). The carton thus produced, however, has following problems.

One problem of the existing carton is its high cost and complicated production. The bottom of the traditional carton is finished by joining multiple pieces together, so that the process is complicated and over-elaborated. Besides, the staples or adhesive tapes used for joining the pieces of the box bottom result in an additional expense, and more production time and energy will be cost to complete the fastening by means of staples or the binding by means of adhesive tapes.

Another problem is that the existing carton is not durable enough so that items contained therein may easily be leaked from the bottom of the carton. Since the traditional carton has the bottom finished by means of the staples or the adhesive tapes, the weight of the items contained therein is strictly limited. Once the carton is lifted or pulled not carefully enough during transportation, the connections of the staples or adhesive tapes on the bottom will be torn so that the items will drop down from the torn bottom.

Yet another problem is that the existing carton does not have an aesthetic appearance, because its bottom, instead of made by a whole piece of a paper board, is formed by piecing together a plurality of divided, small-sized paper boards with staples or adhesive tapes.

Still another problem is that the existing carton, which is joined by means of staples or adhesive tapes, is not eco-friendly, because additional waste that is not good for environmental protection will result therefrom.

Yet another problem is that the existing carton, especially its bottom joined by means of staples, can easily damage (e.g. scratch) the items contained therein.

Thus, apparently, the existing cartons are not convenient and are deficient from the perspective of practical use, and need thus to be improved.

### SUMMARY OF THE INVENTION

In view of the above-mentioned defects, it is an objective of the present invention to provide a carton to overcome at least one of the problems mentioned above.

Another objective of the invention is to provide a method for producing the carton of the invention, which can overcome at least one of the problems mentioned above.

Therefore, the invention provides a carton comprising a body having a top-opened cuboid structure. Said body is formed by cutting, creasing and folding a single sheet of paper board and comprising: a first external wall plate, a second external wall plate, a third external wall plate and a fourth external wall plate, connected sequentially through three creases; an internal bottom plate, connected to a bottom edge of the first external wall plate through a crease; an external bottom plate, connected to a bottom edge of the third external wall plate through a crease; and a second internal wall plate and a fourth internal wall plate, connected respectively to two side edges of the external bottom plate through respective two creases. The folded first, second, third and fourth external wall plates and the folded external bottom plate define the top-opened cuboid structure of the body. The second internal wall plate is folded with respect to the external bottom plate and in contacted with the inner surface of the second external wall plate, while the fourth internal wall plate is folded with respect to the external bottom plate and in contacted with the inner surface of the fourth external wall plate. The internal bottom plate is folded with respect to the first external wall plate and in contacted with the inner surface of the external bottom plate.

According to another aspect of the invention, the second internal wall plate is shaped and configured to match the second external wall plate of the body; while the fourth internal wall plate is shaped and configured to match the fourth external wall plate of the body.

According to another aspect of the invention, the inner bottom plate is shaped and configured to match the external bottom plate of the body.

According to another aspect of the invention, at least one of the second and the fourth internal wall plates is provided thereon with at least one opening; while the corresponding one of the second and the fourth external wall plates is provided thereon with at least one tongue, suitable for being inserted and secured into the at least one opening when the second and the fourth internal wall plates being in contact with the inner surfaces of respective the second and the fourth external wall plates.

According to another aspect of the invention, the first external wall plate is connected at its outer side edge with a connecting plate through a crease, which connecting plate is configured to be fixed to the fourth external wall plate.

According to another aspect of the invention, the carton a cover for covering the top of the body of the carton.

According to another aspect of the invention, the cover is formed by cutting creasing and folding another single sheet of paper board and comprises: a top plate; a first wall plate, a second wall plate, a third wall plate, and a fourth wall plate, connected to four side edges of the top plate, respectively, through four creases; a first retaining plate, connected to an outer side edge of the first wall plate through a crease; a third retaining plate, connected to an outer side edge of the third wall plate through a crease; a first wing and a second wing, connected respectively to two side edges of the second wall plate through respective two creases; and a third wing and a fourth wing connected respectively to the two side edges of the fourth wall plate through respective two creases. The top plate and the first, second, third and fourth wall plates folded with respect to the top plate define a bottom-opened cuboid structure of the cover. The first and the third wings are folded with respect to the second and the fourth wall plates respectively and in contact with the inner surface of the first wall plate, while the second and the fourth wings are folded with respect to the second and the fourth wall plates respectively and in contact with the inner surface of the third wall plate. The first retaining plate is folded with respect to the first wall plate and in contact with the inner surfaces of the first wall plate and the first and third wings; while the third retaining plate is folded with respect to the third wall plate and in contact with the inner surfaces of the third wall plate and the second and fourth wings.

According to another aspect of the invention, at least one slit is provided at the joint between the top plate and the first wall plate; while at least one tongue is correspondingly arranged on the first retaining plate, which is suitable for being inserted and secured into said at least one slit when the first retaining plate is folded and in contact with the inner surfaces of the first wall plate and the first and third wings.

According to another aspect of the invention, at least one slit is provided at the joint between the top plate and the third wall plate; while at least one tongue is correspondingly arranged on the third retaining plate, which is suitable for being inserted and secured into said at least one slit when the third retaining plate is folded and in contact with the inner surfaces of the third wall plate and the second and fourth wings.

The invention further provides a method for producing a carton comprising a body having a top-opened cuboid structure. The method comprises cutting and creasing a single sheet of paper board to form an expanded structure of the body. Said expanded structure comprises: a first, a second, a third and a fourth external wall plates connected sequentially through three creases; an internal bottom plate connected to a bottom edge of the first external wall plate through a crease; an external bottom plate connected to a bottom edge of the third external wall plate through a crease; and a second and a fourth internal wall plates connected respectively to two side edges of the external bottom plate through respective two creases. The method further comprises: folding the first, second, third and fourth external wall plates with respect to each other and connecting the first external wall plate with the fourth external wall plate to form an encircling four-sides structure; folding the internal bottom plate into the four-sides structure; folding the second and the fourth internal wall plates onto the inner surface of the external bottom plate, respectively; folding the external bottom plate together with the folded second and fourth internal wall plates with respect to the third external wall plate so as to close the bottom of the four-sides structure; unfolding the second and the fourth internal wall plates from the external bottom plate and making them be in contact with the inner surfaces of the second and the fourth external wall plates, respectively; and unfolding the inner bottom plate down with respect to the first external wall plate, and placing the inner bottom plate onto the inner surface of the external bottom plate.

According to another aspect of the invention, the method further comprises: shaping and configuring the second internal wall plate to match the second external wall plate; and shaping and configuring the fourth internal wall plate to match the fourth external wall plate.

According to another aspect of the invention, the method further comprises: shaping and configuring the inner bottom plate to match the external bottom plate.

According to another aspect of the invention, the method further comprises: cutting at least one tongue on at least one of the second and the fourth external wall plates; forming at least one opening on the corresponding one of the second and the fourth internal wall plates; and inserting the at least one tongue into the at least one opening and folding the former upwardly to lock the at least one of the second and the fourth external wall plates with the corresponding one of the second and the fourth internal wall plates, when the second and the fourth internal wall plates are in contact with respective the second and the fourth external wall plates.

According to another aspect of the invention, the expanded structure of the body further comprises a connecting plate connected to the outer side edge of the first external wall plate through a crease, wherein the first external wall plate is connected with the fourth external wall plate through fixing the connecting plate to the fourth external wall plate.

According to another aspect of the invention, the method further comprises forming a cover suitable for covering on the top of the body.

According to another aspect of the invention, steps for forming the cover includes cutting and creasing another single sheet of paper board to form an expanded structure of the cover, which comprises: a top plate; a first wall plate, a second wall plate, a third wall plate, and a fourth wall plate, connected to four side edges of the top plate, respectively, through four creases; a first retaining plate, connected to an outer side edge of the first wall plate through a crease; a third retaining plate, connected to an outer side edge of the third wall plate through a crease; a first wing and a second wing, connected respectively to two side edges of the second wall plate through respective two creases; and a third wing and a fourth wing, connected respectively to two side edges of the fourth wall plate through respective two creases. The steps for forming the cover further includes: folding respectively the first, second, third and fourth wall plates with respect to the top plate to form a bottom-opened cuboid structure of the cover; folding the first and the third wings with respect to the second and the fourth wall plates respectively and making them in contact with the inner surface of the first wall plate, and folding the second and the fourth wings with respect to the second and the fourth wall plates respectively and making them in contact with the inner surface of the third wall plate; and folding the first retaining plate with respect to the first wall plate and making it in contact with the inner surfaces of the first wall plate, the first wing and the third wing, and folding the third retaining plate with respect to the third wall plate and making it in contact with the inner surfaces of the third wall plate, the second wing and the fourth wing sheet.

According to another aspect of the invention, the method further comprises: providing at least one first slit at the joint between the top plate and the first wall plate; providing at least one first tongue on the first retaining plate; and inserting the at least one first tongue into the at least one first slit when the first retaining plate is folded and in contact with the inner surfaces of the first wall plate and the first and third wings.

According to another aspect of the invention, the method further comprises: providing at least one third slit at the joint between the top plate and the third wall plate; providing at least one third tongue on the third retaining plate; and inserting the at least one third tongue into the at least one third slit when the third retaining plate is folded and in contact with the inner surfaces of the third wall plate and the second and fourth wings.

The carton of the invention has the advantages of low cost, simple manufacture, firmness, beautiful appearance, eco-friendship, and better item protection. In particularly, the body of the carton according to the present invention is made by folding a single sheet of paper board in such a way that the bottom as well as each of the four walls of the carton body is in the form of an integrated piece of paper board, instead of joining small pieces together, and needing no external tools or materials such as staples or adhesive tapes etc. As compared with the traditional cartons, the carton according to the present invention has the following advantages. First of all, the present carton is produced by fully and reasonably utilizing the whole sheet of the paper board material so as to avoid material waste, thereby reducing the production cost. Besides, since the process for joining multiple pieces together to form the bottom is omitted, the manufacturing process for the carton body is simplified while additional expense for the staples or the adhesive tapes is no longer needed. Furthermore, since the bottom and four walls of the carton body according to the present invention are integrally designed, its structure is more durable and reliable and the entire body is more aesthetic. Moreover, the whole carton body of the present invention is made from paper board material, which makes it more eco-friendly. The paper board material will not damage the items contained in the carton, so that a better protection can be provided for said items. Moreover, the carton according to the present invention has better capabilities of crushing resistance and load bearing than those of the traditional cartons formed by using staples or adhesive tapes.

### BRIEF DESCRIPTION OF THE DRAWINGS

FIG. 1 is an perspective view of the carton according to an embodiment of the present invention;

FIG. 2 is a expanded plane view of an embodiment of the body of carton shown in FIG. 1;

FIG. 3 is a expanded plane view of an embodiment of the cover of carton shown in FIG. 1;

FIGS. 4A to 4E are schematic views showing the processes of folding the body of the carton according to one embodiment of the present invention; and

FIGS. 5A to 5B are schematic views showing the processes of folding the cover of the carton according one embodiment of to the present invention.

### DETAILED DESCRIPTION OF THE PREFERRED EMBODIMENTS

For the purpose of making the objective, features and advantages of the present invention more clear, the present invention is further described and explained in details with reference to the accompanying drawings and embodiments. It should be understood that the embodiments described here intend to explain but not limit the invention.

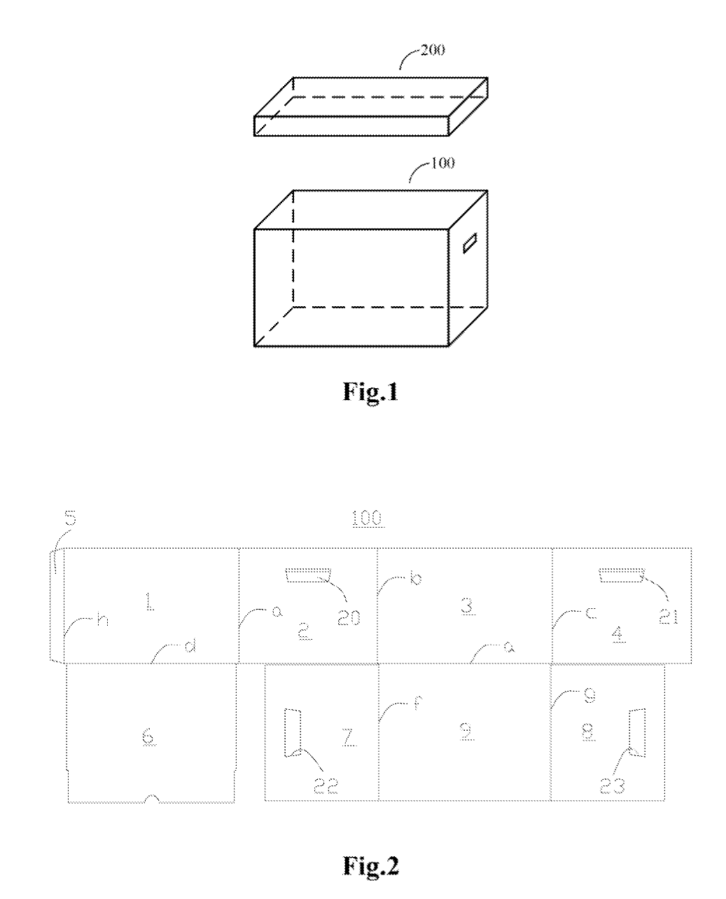

FIG. 1 shows the perspective structure of the carton according to an embodiment of the present invention, which comprises a cubic or cuboid body 100 and a cubic or cuboid cover 200.

The body 100 can be formed from a sheet of paper board, preferably corrugated paper board, through cutting, creasing (to form creases) and folding processes. The cover 200 can also be formed from a sheet of paper board, preferably corrugated paper board, through cutting, creasing and folding processes. The formed cover 200 can be covered onto the top of the formed body 100 to constitute an integrated structure of the carton. The carton of the present invention can be used as an in-tray, a gift box or a storage container, etc., and can have various dimensions and sizes depending on the practical requirement. It should understand that, according to other embodiments of the invention, the carton can have a cover made in other manner, or even have no cover.

As illustrated in FIG. 2, the carton body 100 comprises a first external wall plate 1, a second external wall plate 2, a third external wall plate 3 and a fourth external wall plate 4 which are connected sequentially one by one through creases a, b and c. The first external wall plate 1 is connected at its bottom edge with an internal bottom plate 6 through a crease d. The third external wall plate 3 is connected at its bottom edge with an external bottom plate 9 through a crease e. The external bottom plate 9 is connected at its two side edges respectively with a second internal wall plate 7 and a fourth internal wall plate 8 through respective creases f and g.

The first external wall plate 1, the second external wall plate 2, the third external wall plate 3, the fourth external wall plate 4 and the external bottom plate 9 are folded to form a top-opened cubic or cuboid structure of the body 100. The second internal wall plate 7, which preferably has a shape matching that of the second external wall plate 2, is folded around the crease f and in contact with the inner surface of the second external wall plate 2. The fourth internal wall plate 8, which preferably has a shape matching that of the fourth external wall plate 4, is folded around the crease g and in contact with the inner surface of the fourth external wall plate 4. The internal bottom plate 6, which preferably has a shape matching that of the external bottom plate 9, is folded around the crease d and in contact with the inner surface of the external bottom plate 9. The overlaid internal and external bottom plates 6 and 9 together form the bottom of the carton body 100, so that the bottom of the body, like four walls of the body, is in a integrated form without the joined small-sized pieces and needing no external tools or materials such as staples and adhesive tapes, etc.

The second external wall plate 2 is preferably provided with at least one tongue 20, while the second internal wall plate 7 is correspondingly provided with at least one opening 22, so that the tongue 20 can be inserted and secured into the opening 22 when the second internal wall plate 7 is in contact to the inner surface of the second external wall plate 2. In particularly, the tongue 20 can be inserted into the opening 22 and folded upwardly for locking, so that a hollowed area corresponding to the folded second insert tongue 20 on the second external wall plate 2 can be used as a lifting hole of the carton for manual handling. Similarly, the fourth external wall plate 4 can be preferably provided with at least one tongue 21, while the fourth internal wall plate 8 is correspondingly provided with at least one opening 23, so that the tongue 21 can be inserted and secured into the fourth opening 23 when the fourth internal wall plate 8 is in contact with the inner surface of the fourth external wall plate 4. In particularly, the tongue 21 can be inserted into the opening 23 and folded upwardly for locking, so that a hollowed area corresponding to the folded fourth insert tongue 21 on the fourth external wall plate 4 can be used as another lifting hole of the carton for manual handling. In a preferred embodiment of the invention, two lifting holes of the carton are arranged respective on the second and the fourth external wall plates 2 and 4 above the respective middle positions thereof. Such arrangement allows the carton to be more convenient and durable than the traditional one and to have a carrying capacity up to more than 15 KG when manual lifted.

More preferably, the first external wall plate 1 of the carton body 100 is provided with a connecting plate 5 that is connected to the outer side edge of the first external wall plate 1 through a crease h, so that the connecting plate 5 can be connected and fixed to the fourth external wall plate 4 when the first, second, third and fourth external wall plates 1 to 4 are folded to form a hollowed four-sides structure of the body 100.

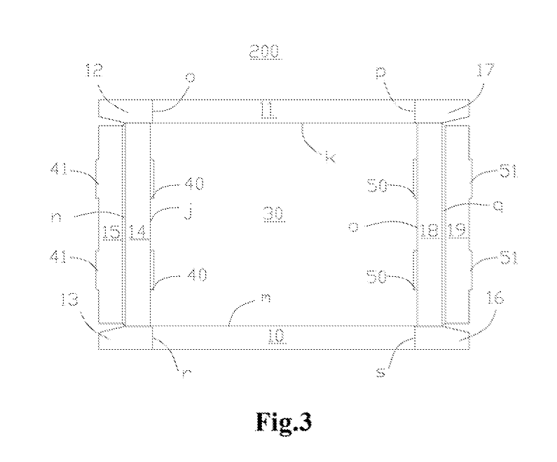

FIG. 3 shows the expanded structure of the carton cover 200 according to a preferable embodiment of the present invention. The cover 200 comprises a top plate 30, and a first, a second, a third and a fourth wall plates 14, 11, 18 and 10, which are connected to four side edges of the top plate 30 respectively through creases j, k, l, and m.

The top plate 30 can be preferably provided with one or more (e.g. two) first elongated slit 40 at the joint between the top plate 30 and the first wall plate 14. The top plate 30 can be also provided with one or more (e.g. two) third elongated slit 50 at the joint between the top plate 30 and the third wall plate 18.

The first wall plate 14 of the cover is connected at its outer side edge to a first retaining plate 15 through a crease n, wherein the first retaining plate 15 is preferably provided with one or more (e.g. two) first slightly convex tongues 41 corresponding to the first slits 40.

The second wall plate 11 of the cover is connected at its two side edges with a first wing 12 and a second wing 17, respectively, through creases o and p.

The third wall plate 18 of the cover is connected at its outer side edge to a third retaining plate 19 through a crease q, wherein the third retaining plate 19 is preferably provided with one or more (e.g. two) third slightly convex tongues 51 corresponding to the third slits 50.

The fourth wall plate 10 of the cover is connected at its two side edges with a third wing 13 and a fourth wing 16, respectively, through creases r and s.

The top plate 30, the first wall plate 14, the second wall plate 11, the third wall plate 18 and the fourth wall plate 10 of the cover can be folded to form a bottom-opened cubic or cuboid structure of the cover 200. The first wing 12 and the third wing 13 are folded around the creases o and r respectively to be in contact with the inner surface of the first wall plate 14, while the second wing 17 and the fourth wing 16 are folded around the creases p and s respectively to be in contact with the inner surface of the third wall plate 18. The first retaining plate 15 is folded around the crease n to be in contact with the inner surfaces of the first wall plate 14, the first wing 12 and the third wing 13, wherein the first tongues 41 of the first retaining plate 15 can be inserted into the first slits 40 of the top plate 30 and secured therein. The third retaining plate 19 is folded around the crease q to be in contact with the inner surfaces of the third wall plate 18, the second wing 17 and the fourth wing 16, wherein the third tongues 51 of the third retaining plate 19 can be inserted into the third slits 50 of the top plate 30 and secured therein.

The present invention also provides a method for producing the carton, which comprises at least steps for forming the body of the carton and can also comprises steps for forming the cover of the carton.

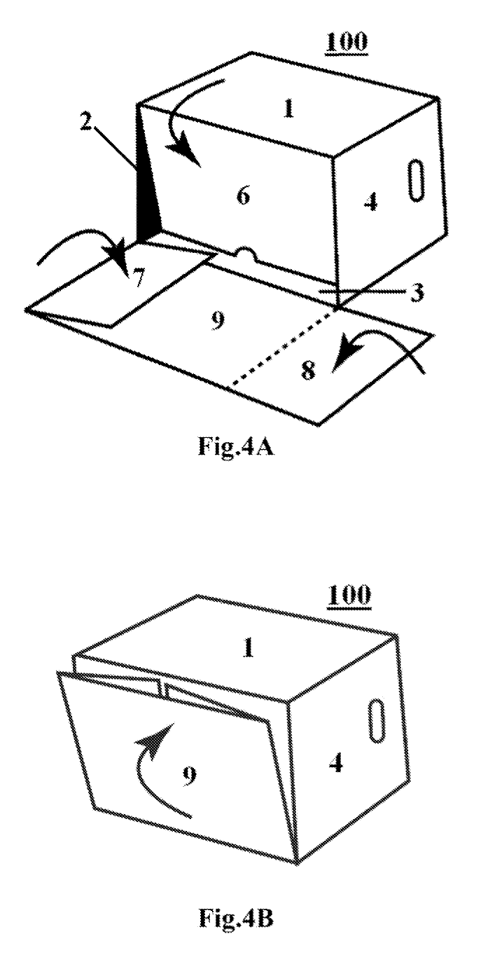

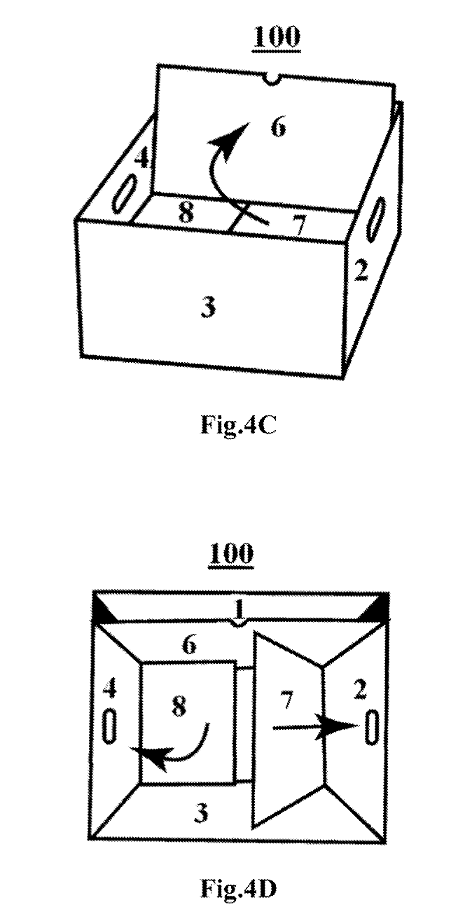

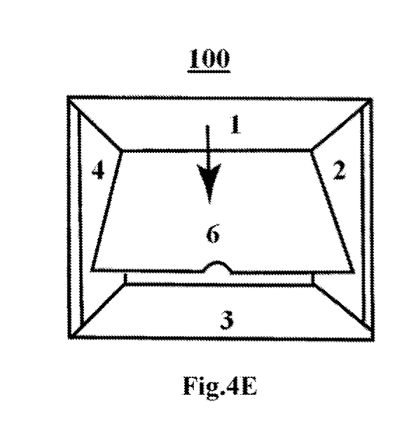

FIGS. 4A to 4E are schematic views showing the processes of folding the body of the carton according to an embodiment of the present invention. The steps for forming the carton body 100 are described in details hereinafter with the reference of FIG. 2.

Firstly, a paper board, preferably a corrugated paper board, is cut and creased to form an expanded structure of the body 100 as illustrated in FIG. 2, which comprises the first, the second, the third and the fourth external wall plates 1 to 4 that are connected sequentially one by one through the creases a to c; the inner bottom plate 6 connected to the bottom edge of the first external wall plate 1 through the crease d; the external bottom plate 9 connected to the bottom edge of the third external wall plate 3 through the crease e; and the second and the fourth internal wall plates 7 and 8 connected to two side edges of the external bottom plate 9, respectively, through the creases f and g. The carton body 100 of the present invention fully and reasonably utilizes the whole sheet of the paper board as far as possible so as to furthest avoid material waste. The second internal wall plate 7 is preferably shaped and configured to match the second external wall plate 2; while the fourth internal wall plate 8 is preferably shaped and configured to match the fourth external wall plate 4. The inner bottom plate 6 is preferably shaped and configured to match the external bottom plate 9. At least one second tongue 20 can be cut from the second external wall plate 2, while at least one second opening 22 can be formed on the second internal wall plate 7 correspondingly. At least one fourth tongue 21 can be cut from the fourth external wall plate 4, while at least one fourth opening 23 can be formed on the fourth internal wall plate 8 correspondingly.

As illustrated in FIG. 4A, the first external wall plate 1, the second external wall plate 2, the third external wall plate 3 and the fourth external wall plate 4 are folded with the first and the fourth ones being fixed to each other to form an encircling four-sides structure, into which the inner bottom plate 6 is folded. Preferably, the connecting plate 5 can be connected to the outer side edge of the first external wall plate 1 of the body 100 through the crease h, so that it can be fixed to the fourth external wall plate 4 when the encircling four-sides structure is formed. In this embodiment, the connecting plate 5 can be folded to the inner surface of the fourth external wall plate 4, and attached thereto by applying glue on both of the contacted surfaces. It should understand that the first external wall plate 1 can be connected and fixed to the fourth external wall plate 4 in other connection manner, such as clamping.

Then, the second internal wall plate 7 and the fourth internal wall plate 8 are respectively folded down to the inner surface of the external bottom plate 9. Then, the external bottom plate 9 with the folded second internal wall plate 7 and fourth internal wall plate 8 can be folded together to close the bottom of the encircling four-sides structure, as illustrated in FIG. 4B.

Then, as illustrated in FIGS. 4C, 4D, the second internal wall plate 7 and the fourth internal wall plate 8, which have been folded to the external bottom plate 9, are unfolded towards the inner surfaces of the second external wall plate 2 and the fourth external wall plate 4, respectively, being in contact therewith and keeping upright.

Finally, as illustrated in FIG. 4E, the inner bottom plate 6 is unfolded down to the inner surface of the external bottom plate 9. Preferably, the second tongue 20 can be inserted into the second opening 22 and folded upwardly to lock the second internal wall plate 7 with the second external one 2, so that the hollowed area corresponding to the folded second tongue 20 on the second external wall plate 2 can be used as the lifting hole of the carton for manual handling. The fourth tongue 21 can be inserted into the fourth opening 23 and then folded upwardly to lock the fourth internal wall plate 8 with the fourth external one 4, so that the hollowed area corresponding to the fourth tongue 21 on the fourth external wall plate 4 can be used as another lifting hole of the carton for manual handling. Up to now, the carton body 100 has been completely produced.

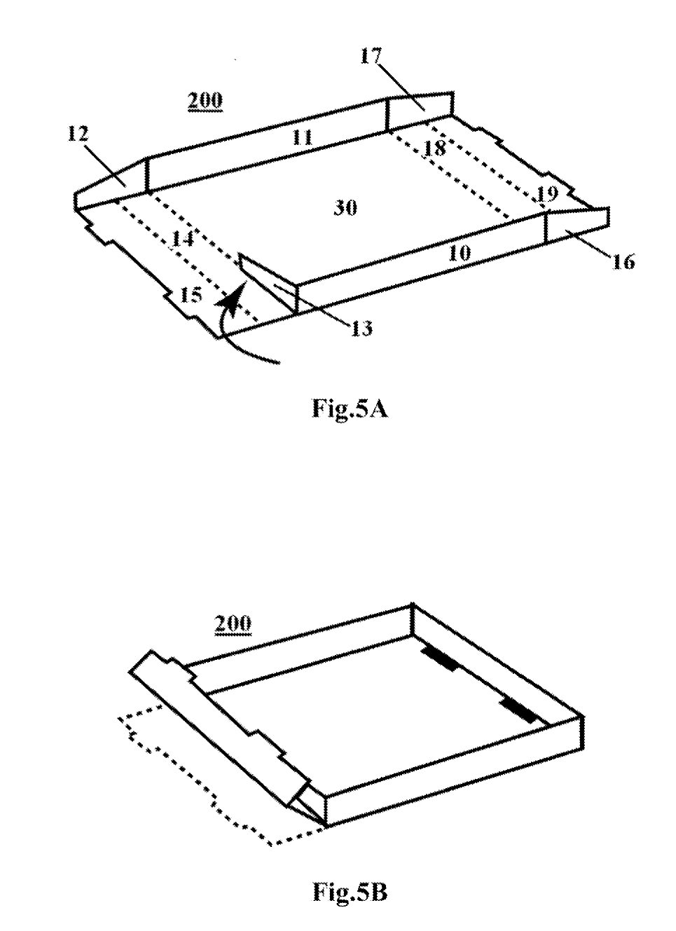

FIGS. 5A to 5B show the processes of folding the carton cover according to an embodiment of the present invention. The steps for forming the cover 200 are particularly described hereinafter with reference of FIG. 3. Although the cover 200 according to the invention can be formed through the steps of cutting, creasing and folding paper board, it can also be formed through a same or similar way as a traditional carton cover.

Firstly, a paper board, preferably a corrugated paper board, can be cut and creased to form an expanded structure of the cover 200 as illustrated in FIG. 3, which comprises a top plate 30; a first cover-body wall plate 14, a second wall plate 11, a third wall plate 18 and a fourth wall plate 10 connected to four side edges of the top plate 30, respectively, through creases j, k, l, and m. One or more first elongated slits 40 can be cut at the joint between the top plate 30 and the first wall plate 14, while One or more third elongated slits 50 can be cut at the joint between the top plate 30 and the third wall plate 18. A first retaining plate 15 can be formed to be connected to the outer side edge of the first wall plate 14 through a crease n, wherein one or more slightly convex first tongues 41 corresponding to the first slits 40 can be formed at the outer side edge of the first retaining plate 15. A first wing 12 and a second wing 17 can be formed to be connected to two side edges of the second wall plate 11, respectively, through creases o and p. A third retaining plate 19 can be formed to be connected to the outer side edge of the third wall plate 18 through a crease q, wherein one or more slightly convex third tongues 51 corresponding to the third slits 50 can be formed at the outer side edge of the third retaining plate 19. A third wing 13 and a fourth wing 16 can be formed to be connected to two side edges of the fourth wall plate 10, respectively, through the creases r and s.

As illustrated in FIG. 5A, FIG. 5B and referring with FIG. 3, the first wall plate 14, the second wall plate 11, the third wall plate 18 and the fourth wall plate 10 can be folded towards the inner surface of top plate 30 to form a bottom-opened cubic or cuboid structure of the cover 200. Then, the first wing 12 and the third wing 13 can be respectively folded to be in contact with the inner surface of the first wall plate 14, while the second wing 17 and the fourth wing 16 can be respectively folded to be in contact with the inner surface of the third wall plate 18. The first retaining plate 15 can be folded to be in contact with the inner surfaces of the first wall plate 14, the first wing 12 and the third wing 13, with the first tongues 41 of the first retaining plate 15 being inserted into the first slits 40 of the top plate 30 for fixing. The third retaining plate 19 can be folded to be in contact with the inner surfaces of the third wall plate 18, the second wing 17 and the fourth wing 16, with the third tongues 51 of the third retaining plate 19 being inserted into the third slits 50 of the top plate 30 for fixing. Thereby, the carton cover 200 has been completely produced. The produced cover 200 can be then covered on the top of the body 100. Now, the processes for producing and assembling the carton of a preferred embodiment of the present invention has been completed.

It is an advantage that the body of the carton according to the present invention is made by folding a single sheet of paper board in such a way that the bottom as well as each of the four walls of the carton body is in the form of an integrated piece of paper board, instead of joining small pieces together, and needing no external tools or materials such as staples or adhesive tapes etc. As compared with the traditional cartons, the carton according to the present invention has the following advantages. First of all, the present carton is produced by fully and reasonably utilizing the whole sheet of the paper board material so as to avoid material waste, thereby reducing the production cost. Besides, since the process for joining multiple pieces together to form the bottom is omitted, the manufacturing process for the carton body is simplified while additional expense for the staples or the adhesive tapes is no longer needed. Furthermore, since the bottom and four walls of the carton body according to the present invention are integrally designed, its structure is more durable and reliable and the entire body is more aesthetic. Moreover, the whole carton body of the present invention is made from paper board material, which makes it more eco-friendly. The paper board material will not damage the items contained in the carton, so that a better protection can be provided for said items. Moreover, the carton according to the present invention has better capabilities of crushing resistance and load bearing than those of the traditional cartons formed by using staples or adhesive tapes.

Although several preferred embodiments of the present invention have been described, the present invention may be used with other configurations. It will be appreciated by those skilled in the art that, the present invention could have many other embodiments, and changes and modifications may be made thereto without departing from the invention in its broader aspects and as set forth in the following claims and equivalents thereof.

What is claimed is:

1. A carton, comprising a body having a top-opened cuboid structure, said body being formed by cutting, creasing and folding a single sheet of paper board and comprising:
a first external wall plate, a second external wall plate, a third external wall plate and a fourth external wall plate, connected sequentially through three creases;
an internal bottom plate, connected to a bottom edge of the first external wall plate through a crease;
an external bottom plate, connected to a bottom edge of the third external wall plate through a crease; and
a second internal wall plate and a fourth internal wall plate, connected respectively to two side edges of the external bottom plate through respective two creases;
wherein the folded first, second, third and fourth external wall plates and the folded external bottom plate define the top-opened cuboid structure of the body;
wherein the second internal wall plate is folded with respect to the external bottom plate and in contacted with the inner surface of the second external wall plate, while the fourth internal wall plate is folded with respect to the external bottom plate and in contacted with the inner surface of the fourth external wall plate, and
wherein the internal bottom plate is folded with respect to the first external wall plate and in contacted with the inner surface of the external bottom plate.

2. The carton according to claim 1, wherein the second internal wall plate is shaped and configured to match the second external wall plate of the body; and
wherein the fourth internal wall plate is shaped and configured to match the fourth external wall plate of the body.

3. The carton according to claim 2, wherein the inner bottom plate is shaped and configured to match the external bottom plate of the body.

4. The carton according to claim 1, wherein at least one of the second and the fourth internal wall plates is provided thereon with at least one opening; while the corresponding one of the second and the fourth external wall plates is provided thereon with at least one tongue suitable for being inserted and secured into said at least one opening when the second and the fourth internal wall plates being in contact with the inner surfaces of respective the second and the fourth external wall plates.

5. The carton according to claim 1, wherein the first external wall plate is connected at its outer side edge with a connecting plate through a crease, which connecting plate is configured to be fixed to the fourth external wall plate.

6. The carton according to claim 1, further comprising a cover for covering the top of the body of the carton.

7. The carton according to claim 6, wherein the cover is formed by cutting creasing and folding another single sheet of paper board and comprises:
a top plate;
a first wall plate, a second wall plate, a third wall plate, and a fourth wall plate, connected to four side edges of the top plate, respectively, through four creases;
a first retaining plate, connected to an outer side edge of the first wall plate through a crease;
a third retaining plate, connected to an outer side edge of the third wall plate through a crease;
a first wing and a second wing, connected respectively to two side edges of the second wall plate through respective two creases; and
a third wing and a fourth wing connected respectively to the two side edges of the fourth wall plate through respective two creases;
wherein the top plate and the first, second, third and fourth wall plates folded with respect to the top plate define a bottom-opened cuboid structure of the cover;
wherein the first and the third wings are folded with respect to the second and the fourth wall plates respectively and in contact with the inner surface of the first wall plate, while the second and the fourth wings are folded with respect to the second and the fourth wall plates respectively and in contact with the inner surface of the third wall plate; and
wherein the first retaining plate is folded with respect to the first wall plate and in contact with the inner surfaces of the first wall plate and the first and third wings; while the third retaining plate is folded with respect to the third wall plate and in contact with the inner surfaces of the third wall plate and the second and fourth wings.

8. The carton according to claim 7, wherein at least one slit is provided at the joint between the top plate and the first wall plate; while at least one tongue is correspondingly arranged on the first retaining plate, which is suitable for being inserted and secured into said at least one slit when the first retaining plate is folded and in contact with the inner surfaces of the first wall plate and the first and third wings.

9. The carton according to claim 7, wherein at least one slit is provided at the joint between the top plate and the third wall plate; while at least one tongue is correspondingly arranged on the third retaining plate, which is suitable for being inserted and secured into said at least one slit when the third retaining plate is folded and in contact with the inner surfaces of the third wall plate and the second and fourth wings.

10. A method for producing a carton comprising a body having a top-opened cuboid structure, the method comprising:
cutting and creasing a single sheet of paper board to form an expanded structure of the body, which comprises: a first, a second, a third and a fourth external wall plates connected sequentially through three creases; an internal bottom plate connected to a bottom edge of the first external wall plate through a crease; an external bottom plate connected to a bottom edge of the third external wall plate through a crease; and a second and a fourth internal wall plates connected respectively to two side edges of the external bottom plate through respective two creases;
folding the first, second, third and fourth external wall plates with respect to each other and connecting the first external wall plate with the fourth external wall plate to form an encircling four-sides structure;
folding the internal bottom plate into the four-sides structure;
folding the second and the fourth internal wall plates onto the inner surface of the external bottom plate, respectively;
folding the external bottom plate together with the folded second and fourth internal wall plates with respect to the third external wall plate so as to close the bottom of the four-sides structure;
unfolding the second and the fourth internal wall plates from the external bottom plate and making them be in contact with the inner surfaces of the second and the fourth external wall plates, respectively; and
unfolding the inner bottom plate down with respect to the first external wall plate, and placing the inner bottom plate onto the inner surface of the external bottom plate.

11. The method according to claim 10, further comprising:
shaping and configuring the second internal wall plate to match the second external wall plate; and
shaping and configuring the fourth internal wall plate to match the fourth external wall plate.

12. The method according to claim 10, further comprising:
shaping and configuring the inner bottom plate to match the external bottom plate.

13. The method according to claim 10, further comprising:
cutting at least one tongue on at least one of the second and the fourth external wall plates;
providing at least one opening on the corresponding one of the second and the fourth internal wall plates; and
inserting the at least one tongue into the at least one opening and folding the former upwardly to lock the at least one of the second and the fourth external wall plates with the corresponding one of the second and the fourth internal wall plates, when the second and the fourth internal wall plates are in contact with respective the second and the fourth external wall plates.

14. The method according to claim 10, wherein the expanded structure of the body further comprises a connecting plate connected to the outer side edge of the first external wall plate through a crease;
wherein the first external wall plate is connected with the fourth external wall plate through fixing the connecting plate to the fourth external wall plate.

15. The method according to claim 10, further comprising forming a cover suitable for covering on the top of the body.

16. The method according to claim 10, wherein the steps for forming the cover include:
cutting and creasing another single sheet of paper board to form an expanded structure of the cover, which comprises:
a top plate;
a first wall plate, a second wall plate, a third wall plate, and a fourth wall plate, connected to four side edges of the top plate, respectively, through four creases;
a first retaining plate, connected to an outer side edge of the first wall plate through a crease;
a third retaining plate, connected to an outer side edge of the third wall plate through a crease;
a first wing and a second wing, connected respectively to two side edges of the second wall plate through respective two creases; and
a third wing and a fourth wing, connected respectively to two side edges of the fourth wall plate through respective two creases;
folding respectively the first, second, third and fourth wall plates with respect to the top plate to form a bottom-opened cuboid structure of the cover;
folding the first and the third wings with respect to the second and the fourth wall plates respectively and making them in contact with the inner surface of the first wall plate, and folding the second and the fourth wings with respect to the second and the fourth wall plates respectively and making them in contact with the inner surface of the third wall plate; and
folding the first retaining plate with respect to the first wall plate and making it in contact with the inner surfaces of the first wall plate, the first wing and the third wing, and folding the third retaining plate with respect to the third wall plate and making it in contact with the inner surfaces of the third wall plate, the second wing and the fourth wing sheet.

17. The method according to claim 16, further comprising:
providing at least one first slit at the joint between the top plate and the first wall plate;
providing at least one first tongue on the first retaining plate; and
inserting the at least one first tongue into the at least one first slit when the first retaining plate is folded and in contact with the inner surfaces of the first wall plate and the first and third wings.

18. The method according to claim 16, further comprising:
providing at least one third slit at the joint between the top plate and the third wall plate;
providing at least one third tongue on the third retaining plate; and
inserting the at least one third tongue into the at least one third slit when the third retaining plate is folded and in contact with the inner surfaces of the third wall plate and the second and fourth wings.
